(19) United States
(12) Patent Application Publication
(10) Pub. No.: US 2017/0183610 A1
(43) Pub. Date: Jun. 29, 2017

(54) MODULAR LIQUID INFUSING, FLAVORING, AND DISPENSING DEVICE

(71) Applicant: Mathew J. KYLE, Yardley, PA (US)

(72) Inventor: Mathew J. KYLE, Yardley, PA (US)

(21) Appl. No.: 15/112,930

(22) PCT Filed: Oct. 17, 2013
(86) PCT No.: PCT/US13/65429

§ 371 Date: Jul. 20, 2016

Related U.S. Application Data
(60) Provisional application No. 61/714,846, filed on Oct. 17, 2012.

(51) Int. Cl. C12C 5/02; B67D 1/12; B67D 1/08; B67D 1/00; B67D 1/04

(52) U.S. Cl. CPC C12C 5/026; B67D 1/0004; B67D 1/04; B67D 1/0857; B67D 1/1272; B67D 2210/00123

(57) ABSTRACT

The present invention is directed to a Modular Liquid Infusing, Flavoring and Dispensing Device that provides a means to infuse flavor into liquids for variable periods of time prior to dispensing, and after the brewing process, wherein the system provides a means to control the rate at which the liquid is dispensed, reduces the trauma to the dispensed liquid, and reduces the amount of foaming in the dispensed liquid. The present invention further provides a method for using the Modular Liquid Infusing, Flavoring, and Dispensing Device.

### FIELD OF THE INVENTION

This invention is in the field of infusing and flavoring liquids for human consumption. The invention relates to a Liquid Infusing, Flavoring, and Dispensing Device. The invention is useful for infusing, flavoring and dispensing alcoholic liquids. The invention is particularly useful for infusing, flavoring and dispensing beer into a drinking vessel.

### BACKGROUND OF THE INVENTION

The practice of infusing and flavoring liquids for human consumption has been used for centuries. Making tea is a good example. It is becoming more common to infuse alcoholic beverages with different flavoring substances. Specialty flavored beers are becoming especially popular. Traditionally, flavor, such as from hops, is infused into the beer during the brewing process. However, many of the delicate aroma and flavor of flavoring substances do not survive the brewing process. The hops that are commonly used to flavor beer are composed of two main parts, Alpha and Beta acids. The Beta acids, which are responsible for most of the aromatic qualities of the beer, are very delicate and do not survive the brewing process. Thus, much of the desired qualities are lost during the brewing process. One solution to the problem of loss of flavor and aroma during the brewing process is to infuse the beer after brewing, and preferable just prior to or during dispensing into a drinking vessel. However, currently available infusing systems subject the beer to trauma during the infusing process, yielding beer that is flat, warm and usually very slow to pour. Moreover, up to 45% of a keg of beer can be lost due to foaming in currently available systems. One such system is described in U.S. Pat. No. 8,245,629.

### BRIEF SUMMARY OF THE INVENTION

The present invention is directed to a Modular Liquid Infusing, Flavoring and Dispensing Device (the “Device of the Invention”) that provides a means to infuse flavor into liquids for variable periods of time prior to dispensing, and after the brewing process, wherein the system provides a means to control the rate at which the liquid is dispensed, reduces the trauma to the dispensed liquid, and reduces the amount of foaming in the dispensed liquid.

The device disclosed herein is referred to as “modular” because the various components thereof (e.g., see FIG. 1) can be swapped out with larger and smaller variations thereof, as long as they share the same basic connection types, and to allow one or more component parts to be removed, cleaned or flushed out, and put back in place without disassembling the entire device.

The present invention is directed to a modular liquid infusing, flavoring and dispensing device comprising:
a) a liquid input line adapted to bring a liquid to be dispensed from a liquid source (e.g., a keg) comprising a first hose member with a first open end, which is a liquid input line inlet passage, and a second open end, which is a liquid input line outlet passage;
b) an infusion chamber comprising a holding means with a first open end, which is an infusion chamber inlet passage, and a second open end, which is an infusion chamber outlet passage;
c) a liquid resistance line comprising a second hose member, with a first open end, which is a liquid resistance line inlet passage, and a second open end, which is a liquid resistance line outlet passage; and
d) a liquid dispensing means comprising a first open end, which is a liquid dispensing means inlet passage, and a second open end, which is a liquid dispensing means outlet passage;
   wherein:
a) the liquid input line outlet passage is adjacent to and in liquid communication with the infusion chamber inlet passage;
b) the holding means of the infusion chamber contains a flavoring substance;
c) the liquid resistance line inlet passage is adjacent to and in communication with the infusion chamber outlet passage; and
d) the liquid resistance line outlet passage is adjacent to and in communication with the liquid dispensing means inlet passage; wherein
   the liquid is drawn from the liquid source and flows through the liquid input line, into the infusion chamber, and flows from the infusion chamber through the liquid resistance line, and flows from the liquid resistance line into the dispensing means; and
      the liquid is dispensed from the liquid dispensing means outlet passage.

In other embodiments, the connections as described above are air tight and liquid tight, wherein the Device of the Invention is a closed system.

In one aspect of the invention, the pressure of the liquid flowing through the device as described above is controlled. In one embodiment, the liquid pressure is higher in the infusion chamber than in the dispensing means. In a more particular aspect, controlling the pressure of the liquid flowing through the system helps to prevent foaming of the liquid.

In one embodiment, the liquid is infused at a pressure ranging from about 0.5 to about 105.00 pounds per square inch. In another embodiment, the liquid is infused at a pressure ranging from about 1.00 to about 100.00 pounds per square inch.

In one embodiment, the liquid is dispensed at a pressure ranging from about 0.01 to about 3.05 pounds per square inch. In another embodiment, the liquid is dispensed at a pressure ranging from about 0.25 to about 3.00 pounds per square inch.

In one aspect of the invention, the pressure of liquid flowing through the device is controlled by varying the internal diameter of the liquid input line and the liquid resistance line.

In one embodiment, the internal diameter of the liquid input line ranges from about 0.01 to about 1.00 inches. In another embodiment, the internal diameter of the liquid input line ranges from about 0.25 to about 0.75 inches.

In one embodiment, the internal diameter of the liquid resistance line ranges from about 0.01 to about 0.50 inches. In another embodiment, the internal diameter of the liquid resistance line ranges from about 0.1875 inches to about 0.250 inches.

In one embodiment the device as described above is kept at a temperature from about 20° F. to about 40° F. In another embodiment, the device as described above is kept at a temperature from about 25° F. to about 35° F.

In one embodiment, the internal volume of the infusion is about 0.5 ounces to about 150 ounces. In another embodiment, the internal volume of the infusion chamber is about 1 ounce to about 100 ounces.

In one embodiment, Device of the Invention further comprises a modular pipe housing tower member.

In one embodiment, the Device of the Invention further comprises an overflow chamber, which comprises a holding means.

In one embodiment, the Device of the Invention further comprises a pressure relief valve.

In one embodiment, the Device of the Invention further comprises a shut off valve.

In one embodiment, the Device of the Invention comprises:
a) a modular pipe housing tower, wherein the modular pipe housing tower further comprises:
   a. a base member, wherein the base member has a hole in the center;
   b. a pipe tower member, wherein a first open end of the pipe tower member is adjacent to and in communication with the center hole of the base member;
   c. a first gasket between the base means and the pipe tower means wherein the gasket is adjacent to and in communication with both the base member and the pipe tower member;
   d. a first pin clamp member, wherein the pin clamp holds the pipe tower member to the base member;
   e. a pipe neck member, wherein a first open end of the pipe neck member is adjacent to and in communication with the second open end of the of the pipe tower member;
   f. a second gasket between the second open end of the pipe tower member and the first open end of the pipe neck member; and
   g. a second pin clamp member, wherein the pin clamp holds the pipe neck member to the pipe tower member;
b) a first hose barb junction wherein the first hose barb junction further comprises:
   a. an inlet passage (first open end);
   b. an outlet passage (second open end);
   c. a hose barb connection;
   d. a gasket between the first open end/inlet passage of the first hose barb junction and the second open end of the pipe neck member;
   e. a third pin clamp member, wherein the pin clamp member holds the first open end/inlet passage to the second open end of the pipe neck member;
c) a first hose member connected to the liquid source, wherein the hose member runs up inside of the pipe tower member and the pipe neck member to connect to hose barb connection of the first hose barb junction.
d) a first holding means for holding the foam overflow, wherein the first holding means further comprises:
   a. an inlet passage, wherein the inlet passage is adjacent to and in communication with a second open end of the first hose barb junction;
   b. a float valve;
   c. a gasket between the second open end of the hose barb junction and the inlet passage of the first holding means, wherein the gasket is adjacent to and in communication with both the second open end of the first hose barb junction and the inlet passage of the first holding means;
   d. a fourth pin clamp member, wherein the fourth pin clamp member holds the inlet passage of the first holding means to the second open end of the first hose barb junction;
   e. a first outlet passage;
   f. a pressure relief valve;
   g. a gasket between the pressure relief valve and the first outlet passage of the first holding means, wherein the gasket is adjacent to and in communication with both the pressure relief valve and the first outlet passage of the first holding means;
   h. a fifth pin clamp member, wherein the fifth pin clamp member holds the pressure relief valve to the first outlet passage of the first holding means;
   i. a second outlet passage;
   j. a first micron filter inside the first holding means wherein the first micron filter is adjacent to and in communication with the second outlet passage of the first holding means;
e) a shut off valve, wherein the shut off valve further comprises;
   a. a first open end inlet passage
   b. a second open end outlet passage
   c. a first gasket between the first open end inlet passage of the shut off valve and the second outlet passage of the first holding means;
   d. a sixth pin clamp member, wherein the sixth pin clamp member holds the first holding means to the first open inlet passage of the shut off valve.
   e. a second gasket between the second open end outlet passage and the first open end of the second holding means;
   f. a seventh pin clamp member, wherein the seventh pin clamp member holds the second open end outlet passage of the shutoff valve to the inlet passage of the second holding means.
f) a second holding means, wherein the second holding means further comprises:
   a. an inlet passage of the second holding means, wherein the inlet passage of the second holding means is adjacent to and in communication with the second open end outlet passage of the shut off valve;
   b. a gasket between the inlet passage of the second holding means and the second open end outlet passage of the shut off valve, wherein the gasket is adjacent to and in communication with both the outlet passage of the first holding means and the second open end outlet passage of the shut off valve;
g) a second hose barb junction which further comprises:
   a. an inlet passage;
   b. and outlet passage;
   c. a first open end;
   d. a second open end;
   e. a hose barb connection;
   f. a second micron filter wherein the second micron filter is adjacent to and in communication with the first open end of the second hose barb junction and the outlet of the second holding means;
   g. a gasket between the first open end of the second hose barb junction and the first outlet passage of the second holding means wherein the gasket is adjacent to and in communication with both the first open end of the second hose barb junction and the outlet passage of the second holding means;
   h. an eighth pin clamp member that holds the first open end of the second hose barb junction to the outlet of the second holding means.
h) a cover for the second hose member further comprising:
   a. a first open end;
   b. a second open end;
   c. a gasket between the first open end of the cover for the second hose member and the second open end of the second hose barb junction wherein the gasket is adjacent to and in communication with both the first open end of the cover for the second hose member and the second open end of the second hose barb junction;
   d. a ninth pin clamp member that holds the first open end of the cover for the second hose member to the second open end of the second hose barb junction;
i) a second hose member that connects to the hose barb connection on the second hose barb junction and to a dispensing faucet.

### DESCRIPTION OF THE DRAWINGS

FIG. 1 is a side planar view of a non-limiting example of a Modular Liquid Infusing, Flavoring, and Dispensing Device according to the invention, wherein: 1 is a pipe tower member, 2 is a pipe neck member, 3 is a first hose barb junction; 4 is a pressure relief valve; 5 is a first holding means (for foam overflow); 6 is a shut-off valve; 7 is a second holding means (infusion chamber);—8 is a second hose barb junction; 9 is a dispensing faucet; and 10 is an aesthetic cover for the second hose member.

FIG. 2 is a top planar view of a gasket wherein: 11) is a sealing rim (made of, for example, silicone); and 12 is the mesh filter.

FIG. 3 is a side planar view of a gasket wherein 11 and 12 are as defined for FIG. 2.

FIG. 4 is a perspective top planar view of a gasket wherein 11) and 12 are as defined for FIG. 2.

FIG. 5 is a perspective planar view of a gasket showing the sock-shape mesh portion 13.

### DETAILED DESCRIPTION OF THE INVENTION

The present invention is directed to a Modular Liquid Infusing, Flavoring and Dispensing Device that provides a means to infuse flavor into liquids for variable periods of time prior to dispensing, and after the brewing process, wherein the system provides a means to control the rate at which the liquid is dispensed, reduces the trauma to the dispensed liquid, and reduces the amount of foaming in the dispensed liquid.

The invention includes a process and a device for infusing aroma and flavor into a liquid, preferably beer, by allowing the liquid from a tapped source to contact a flavor enhancing solid material for a variable period of time prior to entering a drinking container such as a beer glass. This is accomplished by using the device of the invention that contains the solid flavor-enhancing material in such a fashion that the solid material contacts the liquid after the liquid leaves the tap, but before dispensing the liquid, in such a manner that the flavor-enhancing solid material does not flow into the drinking container. The device has an infusion chamber and optionally one or more additional in-line chambers, wherein the infusion chamber contains a flavor-enhancing solid material, and wherein each chamber is bounded on either end of the flow system with a shut-off valve/clamp allowing simple replacement, re-filling, or cleaning of the chamber without disconnecting the overall system from the tapped source. The infusion chamber can optionally be vacuum-jacketed which allows continuous circulation of a cooling solution such as glycol or ice water around the dispensing outlet to regulate the final temperature of the liquid dispensed into the drinking container. This chamber may optionally be filled with solid cooling materials as well, including dry ice or standard ice from water. The overall system is designed to produce a flavored beer or other beverage with minimal foaming and at the optimal drinking temperature to enhance the aroma and drinking experience.

The present invention is directed to a modular liquid infusing, flavoring and dispensing device comprising:
a) a liquid source comprising a first holding means with an open end, the liquid source outlet passage;
b) a liquid input line comprising a first hose member with a first open end, the liquid input line inlet passage, and a second open end, the liquid input line outlet passage;
c) an infusion chamber comprising a holding means with a first open end, the infusion chamber inlet passage, and a second open end, the infusion chamber outlet passage;
d) a liquid resistance line comprising a second hose member, with a first open end, the liquid resistance line inlet passage, and a second open end, the liquid resistance line outlet passage; and
e) a liquid dispensing means comprising a first open end, the liquid dispensing means inlet passage, and a second open end, the liquid dispensing means outlet passage;
   wherein:
a) the liquid input line inlet passage is adjacent to and in liquid communication with the liquid source outlet passage;
b) the liquid input line outlet passage is adjacent to and in liquid communication with the inlet passage of the infusion chamber;
c) the infusion chamber contains a flavoring substance;
d) the liquid resistance line inlet passage is adjacent to and in liquid communication with the outlet passage of the infusion chamber;
e) the outlet passage of the liquid resistance line is adjacent to and in liquid communication with the inlet passage of the liquid dispensing means;
f) the liquid is drawn from the liquid source and flows through the liquid input line, into the infusion chamber, and flows from the infusion chamber into the liquid resistance line, and flows from the liquid resistance line into the dispensing means; and
g) the liquid is dispensed from the outlet passage of the dispensing means.

In certain embodiments, the connections as described above are air tight and liquid tight, wherein the Device of the Invention is a closed system.

In one aspect of the invention, the pressure of the liquid flowing through the device as described above is controlled. In one embodiment, the liquid pressure is higher in the infusion chamber than in the dispensing means. In a more particular aspect, controlling the pressure of the liquid flowing through the system helps to prevent foaming of the liquid.

In one embodiment, the liquid is infused at a pressure ranging from about 0.5 to about 105.00 pounds per square inch. In another embodiment, the liquid is infused at a pressure ranging from about 1.00 to about 100.00 pounds per square inch.

In one embodiment, the liquid is dispensed at a pressure ranging from about 0.01 to about 3.05 pounds per square inch. In another embodiment, the liquid is dispensed at a pressure ranging from about 0.25 to about 3.00 pounds per square inch.

In one aspect of the invention, the pressure of liquid flowing through the device is controlled by varying the internal diameter of the liquid input line and the liquid resistance line.

In one embodiment, the internal diameter of the liquid input line ranges from about 0.01 to about 1.00 inches. In another embodiment, the internal diameter of the liquid input line ranges from about 0.25 to about 0.75 inches.

In one embodiment, the internal diameter of the liquid resistance line ranges from about 0.01 to about 0.50 inches. In another embodiment, the internal diameter of the liquid resistance line ranges from about 0.1875 inches to about 0.250 inches.

In one embodiment the device as described above is kept at a temperature from about 20° F. to about 40° F. In another embodiment, the device as described above is kept at a temperature from about 25° F. to about 35° F.

In one embodiment, the internal volume of the infusion is about 0.5 ounces to about 150 ounces. In another embodiment, the internal volume of the infusion chamber is about 1 ounce to about 100 ounces.

In one embodiment, Device of the Invention further comprises a modular pipe housing tower member.

In one embodiment, the Device of the Invention further comprises an overflow chamber, which comprises a holding means.

In one embodiment, the Device of the Invention further comprises a pressure relief valve.

In one embodiment, the Device of the Invention further comprises a shut off valve.

In one embodiment, the Device of the Invention comprises:
a) a modular pipe housing tower, wherein the modular pipe housing tower further comprises:
   a. a base member, wherein the base member has a hole in the center;
   b. a pipe tower member, wherein a first open end of the pipe tower member is adjacent to and in communication with the center hole of the base member;
   c. a first gasket between the base means and the pipe tower means wherein the gasket is adjacent to and in communication with both the base member and the pipe tower member;
   d. a first pin clamp member, wherein the pin clamp holds the pipe tower member to the base member;
   e. a pipe neck member, wherein a first open end of the pipe neck member is adjacent to and in communication with the second open end of the of the pipe tower member;
   f. a second gasket between the second open end of the pipe tower member and the first open end of the pipe neck member; and
   g. a second pin clamp member, wherein the pin clamp holds the pipe neck member to the pipe tower member;
b) a first hose barb junction wherein the first hose barb junction further comprises:
   a. an inlet passage (first open end);
   b. an outlet passage (second open end);
   c. a hose barb connection;
   d. a gasket between the first open end/inlet passage of the first hose barb junction and the second open end of the pipe neck member;
   e. a third pin clamp member, wherein the pin clamp member holds the first open end/inlet passage to the second open end of the pipe neck member;
c) a first hose member connected to the liquid source, wherein the hose member runs up inside of the pipe tower member and the pipe neck member to connect to hose barb connection of the first hose barb junction.
d) a first holding means for holding the foam overflow, wherein the first holding means further comprises:
   a. an inlet passage, wherein the inlet passage is adjacent to and in communication with a second open end of the first hose barb junction;
   b. a float valve;
   c. a gasket between the second open end of the hose barb junction and the inlet passage of the first holding means, wherein the gasket is adjacent to and in communication with both the second open end of the first hose barb junction and the inlet passage of the first holding means;
   d. a fourth pin clamp member, wherein the fourth pin clamp member holds the inlet passage of the first holding means to the second open end of the first hose barb junction;
   e. a first outlet passage;
   f. a pressure relief valve;
   g. a gasket between the pressure relief valve and the first outlet passage of the first holding means, wherein the gasket is adjacent to and in communication with both the pressure relief valve and the first outlet passage of the first holding means;
   h. a fifth pin clamp member, wherein the fifth pin clamp member holds the pressure relief valve to the first outlet passage of the first holding means;
   i. a second outlet passage;
   j. a first micron filter inside the first holding means wherein the first micron filter is adjacent to and in communication with the second outlet passage of the first holding means;
e) a shut off valve, wherein the shut off valve further comprises;
   a. a first open end inlet passage
   b. a second open end outlet passage
   c. a first gasket between the first open end inlet passage of the shut off valve and the second outlet passage of the first holding means;
   d. a sixth pin clamp member, wherein the sixth pin clamp member holds the first holding means to the first open inlet passage of the shut off valve.
   e. a second gasket between the second open end outlet passage and the first open end of the second holding means;
   f. a seventh pin clamp member, wherein the seventh pin clamp member holds the second open end outlet passage of the shutoff valve to the inlet passage of the second holding means.
f) a second holding means, wherein the second holding means further comprises:
   a. an inlet passage of the second holding means, wherein the inlet passage of the second holding means is adjacent to and in communication with the second open end outlet passage of the shut off valve;
   b. a gasket between the inlet passage of the second holding means and the second open end outlet passage of the shut off valve, wherein the gasket is adjacent to and in communication with both the outlet passage of the first holding means and the second open end outlet passage of the shut off valve;
g) a second hose barb junction which further comprises:
   a. an inlet passage;
   b. and outlet passage;
   c. a first open end;
   d. a second open end;
   e. a hose barb connection;
   f. a second micron filter wherein the second micron filter is adjacent to and in communication with the first open end of the second hose barb junction and the outlet of the second holding means;
   g. a gasket between the first open end of the second hose barb junction and the first outlet passage of the second holding means wherein the gasket is adjacent to and in communication with both the first open end of the second hose barb junction and the outlet passage of the second holding means;
   h. an eighth pin clamp member that holds the first open end of the second hose barb junction to the outlet of the second holding means.
h) a cover for the second hose member further comprising:
   a. a first open end;
   b. a second open end;
   c. a gasket between the first open end of the cover for the second hose member and the second open end of the second hose barb junction wherein the gasket is adjacent to and in communication with both the first open end of the cover for the second hose member and the second open end of the second hose barb junction;
   d. a ninth pin clamp member that holds the first open end of the cover for the second hose member to the second open end of the second hose barb junction;
i) a second hose member that connects to the hose barb connection on the second hose barb junction and to a dispensing faucet.

In one embodiment, the second holding means is cylindrical. The cylindrical shape is preferred to provide maximum pressure resistance.

In another embodiment, the second holding means is comprised of glass.

In another embodiment, the second holding means is comprised of industrial grade glass.

In another embodiment, the second holding means is comprised of tempered industrial grade glass.

In another embodiment, the edges of the second holding means are fire-polished.

In one embodiment, the second holding is optionally vacuum-jacketed.

In another embodiment, the vacuum jacket surrounding the second holding means contains a continuous circulation of a cooling solution.

In another embodiment, the cooling solution is glycol.

In another embodiment, the cooling solution is ice water.

In another embodiment, the vacuum jacket is filled with solid cooling materials.

In another embodiment, the vacuum jacket is filled with dry ice.

In another embodiment, the vacuum jacket is filled with water ice.

In one embodiment, the pipe tower member and the pipe neck member are comprised of stainless steel.

In another embodiment, the pipe tower member and the pipe neck member are comprised of food industry grade stainless steel.

In one embodiment, the gaskets are comprised of silicone. Silicone gaskets are preferred because they are more resistant to gas and liquid leaks.

In another embodiment, the gaskets are comprised of BUNA gasket material (nitrile rubber).

In another embodiment, the gaskets are comprised of Viton® (fluoroelastomer; DuPont).

In another embodiment, the gaskets are made of Teflon® (polytetrafluoroethylene; DuPont).

In one embodiment, the first hose member and the second hose member are comprised of Vinyl.

In one embodiment, the first hose member has an internal diameter of about 3/16″ to about 1″.

In another embodiment, the first hose member has in internal diameter of about 3/16″ to about 2″.

In another embodiment, the first hose member has an internal diameter of about 3/16″ to about ⅜″.

In another embodiment, the first hose member has an internal diameter of about ⅜″.

In one embodiment, the second hose member has an internal diameter of about 3/16″ to about 1″.

In another embodiment, the second hose member has an internal diameter of about 3/16″ to about ½″.

In another embodiment, the second hose member has an internal diameter of about 3/16″ to about ⅜″.

In another embodiment, the second hose member has an internal diameter of about 3/16″.

In one embodiment, the walls of the first and second hose members are about ½″ thick.

In one embodiment, the second hose member is from about 4″ to about 40″ long.

In another embodiment, the second hose member is from about 4″ to about 20″ long.

In another embodiment, the second hose member is from 4″ to about 10″ long.

In one embodiment, the micron filters have a pore size of 10 mesh.

In one embodiment, the micron filters are convex, forming a sock shape, wherein the long end of the sock shaped micron filter protrudes into the holding means.

In one embodiment, the cover for the second hose member is filled with a cooling means.

In one embodiment, the second holding means contains a solid flavoring substance. The solid flavoring substance can be anything that imparts an appealing flavor to the liquid, such as fruit (for e.g. strawberries, lemons, limes, peach, pomegranate, watermelon, raspberries, blueberries, banana, kiwi, etc.), vanilla beans, cinnamon sticks, malted barley, beer hops, ice cream, any kind of non-powdered spice, coffee beans (whole, not ground), chocolate, oak chips, donut hoses, any kind of semi-solid dessert item (for e.g. cheesecake, crème brulee), bacon, ginger root oranges, grapefruit, candies (for e.g. peanut butter cups, chocolate pieces, truffles, etc.). The foregoing list of flavoring substances is representative, and does not limit the flavoring substance that can be used.

In another embodiment, the flavoring substance is hops.

In one embodiment the liquid is an alcoholic beverage.

In another embodiment, the liquid is beer.

In one embodiment, the Devise of the Invention comprises:
a) a first holding chamber with a first inlet, a first outlet, and a second outlet;
b) a first filter connected to the first inlet and between the first inlet and the first and second outlets;
c) a pressure release valve connected to the first outlet;
d) a shut off valve connected to the second outlet; and
e) a second holding chamber with a second inlet, a third outlet, and a second filter, where the second inlet is connected to the shut off valve, the second filter is inside the second holding chamber, and the second holding chamber is adapted to hold a flavoring substance.

The present invention is directed to a process for using the modular liquid infusing, flavoring and dispensing device to flavor a liquid wherein the liquid from a tapped source is in liquid communication with the first hose member, the inlet passage of the first holding means, the outlet passage of the first holding means, the inlet passage of the second holding means, the third hose member, and the tap member.

In one embodiment of the process of the invention, the pressure relief valve is opened, causing the modular liquid infusing, flavoring and dispensing device to fill with more liquid volume.

In one embodiment, the liquid that is infused, flavored and dispensed is an alcoholic beverage.

In another embodiment, the liquid is beer.

In a non-limiting embodiment, the device of the invention is configured as follows, a first hose member is connected to the tap source. In reference to the appended Figures, a first hose member runs up through the pipe tower housing 1, 2, and connects to the hose barb of the first hose barb junction 3). Liquid from the tapped source flows through the first hose member to fill the first holding means 5. A filter gasket 11, 12 is situated at the top of the first holding means between the first hose barb junction and the first holding means helps to prevent foaming of the liquid. This filter gasket, located at the highest connection-clamp position on the device, serves to prevent foam from passing through while allowing air to exit, thereby reducing foaming out of the pressure relief valve 4 located at the top of the first holding means. The pressure relief valve controls the rate at which gas leaves the system, and controls the rate at which liquid enters the system. The pressure relief valve gives the user/operator more control over the fill rate, thus further aiding the control over foaming of the liquid.

The liquid flows into the second holding means through the outlet passage of the first holding means (5) and through the inlet passage of the second holding means (7). There is a gasket at the top of the second holding means between the outlet passage of the first holding means and the inlet passage of the second holding means. The gasket mesh size ranges from about 4 mesh to about 20 mesh, and is preferably about 10 mesh. The gasket is preferably sock-shaped, extending about 4 inches to about 6 inches into the infusion chamber. When a flat gasket is used at the top of the second holding means/infusion chamber, foam tends to stack on the flat gasket when liquid passes through. Using a sock-shaped gasket increases the surface area of the gasket, thus reducing compaction of the flavoring substance, and reducing the foaming of the liquid in the device.

The second holding means/infusion chamber contains the flavoring substance. A better infusing effect results from the passing friction motion of the liquid traveling at faster speeds through the flavoring substance. To maximize that effect, the system is built long and narrow to encourage the liquid to travel quickly through the infusion chamber. To achieve this effect, the internal diameter of the infusion chamber is from about 1″ to about 6″. Preferably, the internal diameter of the infusion chamber is no greater than about 3″.

There is a filter gasket at the bottom of the infusion chamber. At the bottom of the infusion chamber, below the gasket, there is a “hose terminus.” The hose terminus is a second hose barb junction. The hose terminus provides a recessed space below the lower filter gasket at the bottom of the infusion chamber. The hose terminus provides a recessed space beneath the lower filter gasket. The space beneath the lower filter gasket fills with liquid, and improves flow rate because the liquid in the recessed space covalently “pulls” the liquid in the infusion chamber across the filter gasket. There is a hose barb at the outlet passage of the hose terminus to which the second hose member (#) is attached. The second hose member is attached at the other end to the faucet. The second hose member ranges from about 4″ to about 40″ long. Shorter lengths increase the flow rate, whereas longer lengths decrease the flow rate of the liquid.

The modular liquid infusing, flavoring and dispensing device of the present invention has zero dead volume, and therefore can recover all of the liquid infused from the tapped source. This happens because the liquid enters the system at the highest point and exits at the lowest point, allowing the device to be completely drained of all of the liquid being infused.

Turning the shut off valve (6) to the “OFF” (flow stop) position allows the complete draining of the liquid in the infusion chamber, so that the infusion chamber can be refilled, removed, or replaced without the need to disconnect the system from the tapped source.

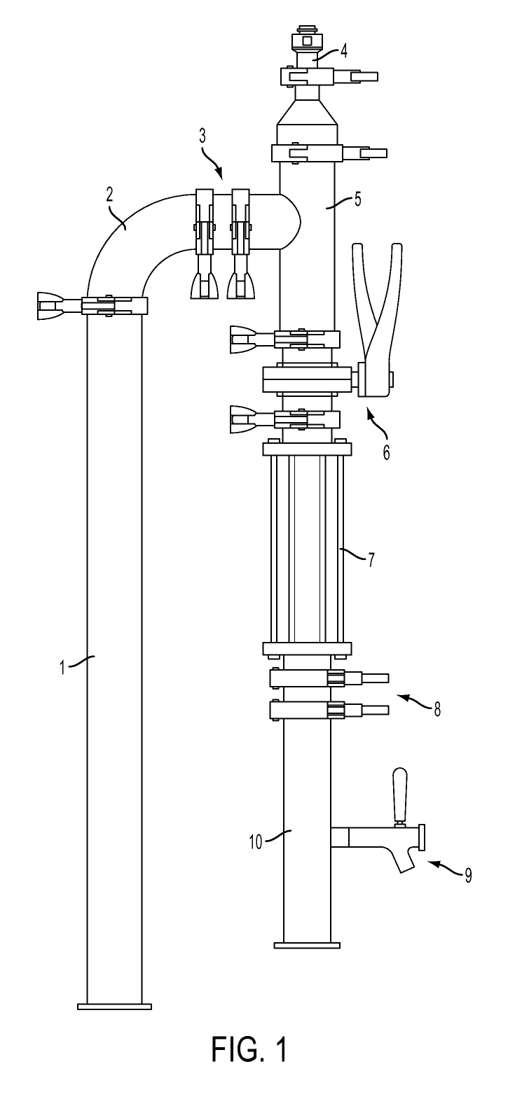

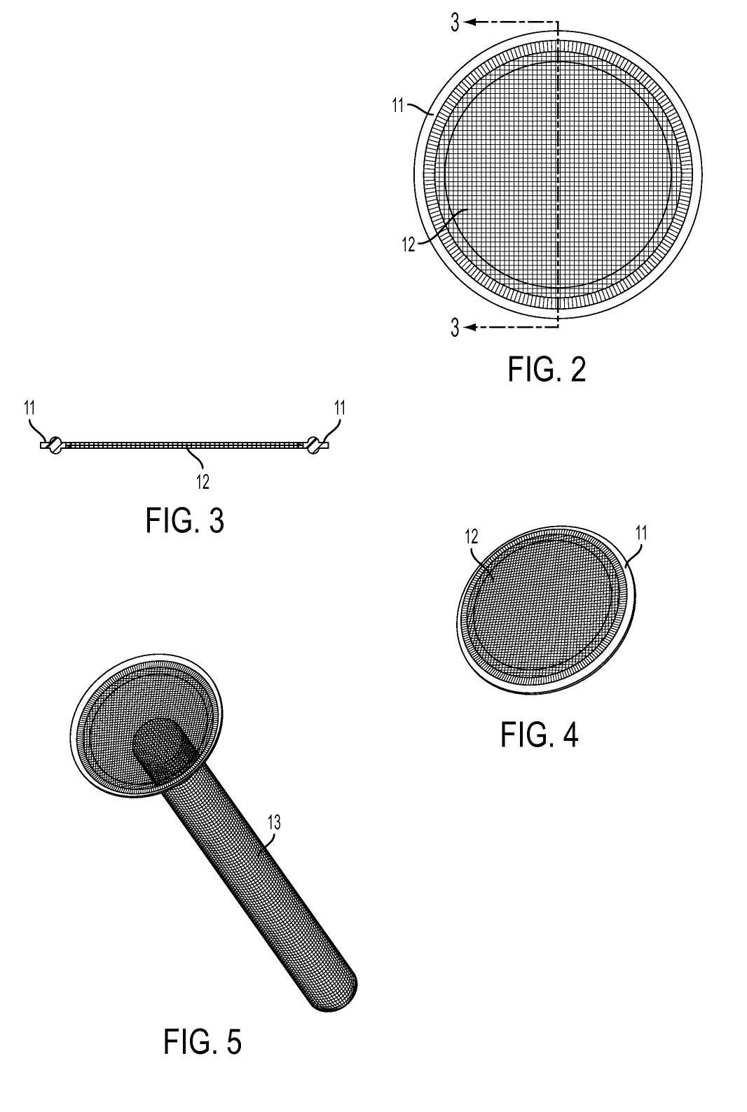

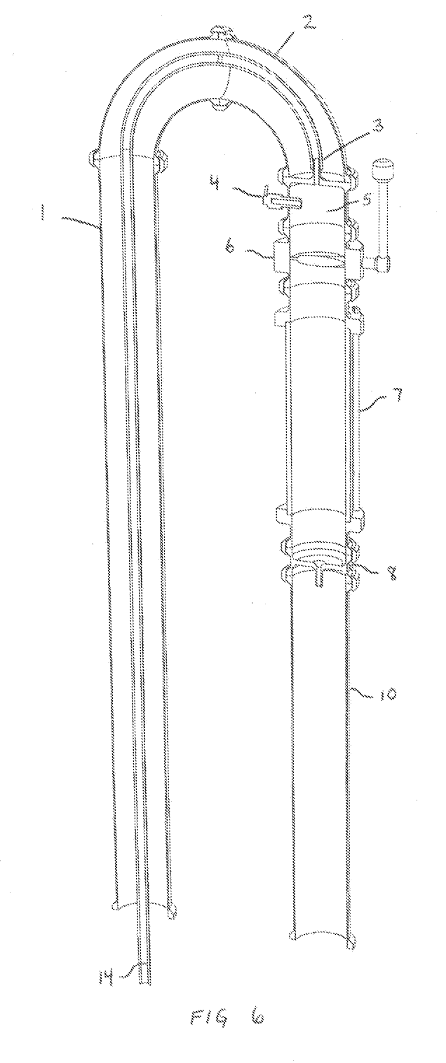

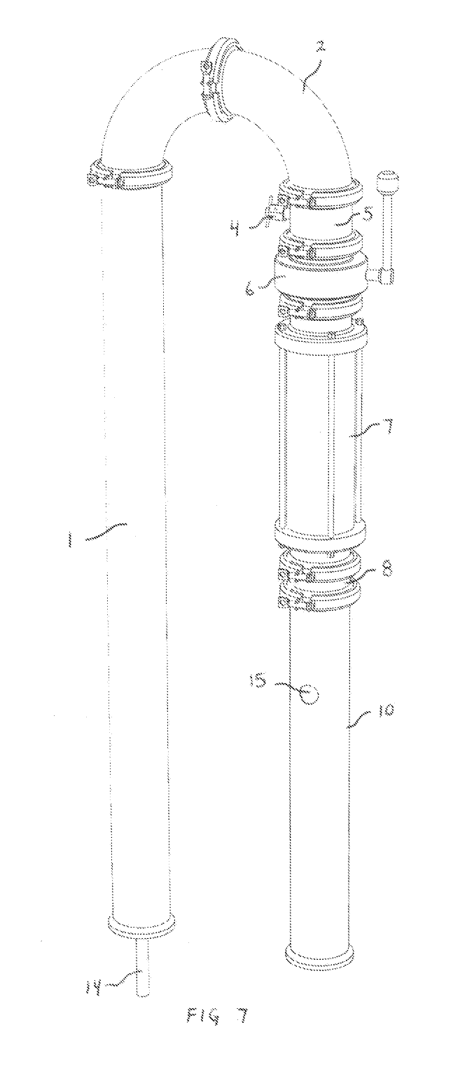

The device of the present invention can be variously configured based on its modular construction. With reference to FIG. 1, one embodiment of the device comprises first holding means 5, which is in liquid communication with second holding means 7, which is in liquid communication with dispensing faucet 9. In a particular embodiment, the device consists of first holding means 5, which is in liquid communication with second holding means 7, which is in liquid communication with dispensing faucet 9.

Another embodiment of the device comprises first holding means 5, which is in liquid communication with shut off valve 6, which is in liquid communication with second holding means 7, which is in liquid communication with dispensing faucet 9. In a particular embodiment, the device consists of first holding means 5, which is in liquid communication with shut off valve 6, which is in liquid communication with second holding means 7, which is in liquid communication with dispensing faucet 9.

Another embodiment of the device comprises first holding means 5, which is in liquid communication with shut off valve 6, which is in liquid communication with second holding means 7, which is in liquid communication with second hose barb junction 8, which is in liquid communication with dispensing faucet 9. In a particular embodiment, the device consists of first holding means 5, which is in liquid communication with shut off valve 6, which is in liquid communication with second holding means 7, which is in liquid communication with second hose barb junction 8, which is in liquid communication with dispensing faucet 9.

Any of the aforementioned embodiments can further consist of a pressure relief valve 4.

Any of the aforementioned embodiments can further consist of an esthetic cover 10.

Any of the aforementioned embodiments can further consist of a first hose barb 3.

Any of the aforementioned embodiments can further consist of a pipe neck member 2.

Any of the aforementioned embodiments can further consist of a pipe tower member 1.

The present invention is not to be limited in scope by the specific embodiments disclosed in the examples that are intended as illustrations of a few aspects of the invention and any embodiments that are functionally equivalent are within the scope of this invention.

Indeed, various modifications of the invention in addition to those shown and described herein will become apparent to those skilled in the art and are intended to fall within the scope of the appended claims.

Any references cited herein are incorporated by reference in their entireties for all purposes.

1. A modular liquid infusing, flavoring and dispensing device comprising:
a) a modular pipe housing tower, wherein the modular pipe housing tower further comprises:
a. a base member, wherein the base member has a hole in the center;
b. a pipe tower member, wherein a first open end of the pipe tower member is adjacent to and in communication with the center hole of the base member;
c. a first gasket between the base means and the pipe tower means wherein the gasket is adjacent to and in communication with both the base member and the pipe tower member;
d. a first pin clamp member, wherein the pin clamp holds the pipe tower member to the base member;
e. a pipe neck member, wherein a first open end of the pipe neck member is adjacent to and in communication with the second open end of the of the pipe tower member;
f. a second gasket between the second open end of the pipe tower member and the first open end of the pipe neck member; and
g. a second pin clamp member, wherein the pin clamp holds the pipe neck member to the pipe tower member;
b) a first hose barb junction wherein the first hose barb junction further comprises:
a. an inlet passage (first open end);
b. an outlet passage (second open end);
c. a hose barb connection;
d. a gasket between the first open end/inlet passage of the first hose barb junction and the second open end of the pipe neck member;
e. a third pin clamp member, wherein the pin clamp member holds the first open end/inlet passage to the second open end of the pipe neck member;
c) a first hose member connected to the liquid source, wherein the hose member runs up inside of the pipe tower member and the pipe neck member to connect to the hose barb connection of the first hose barb junction;
d) a first holding means for holding the foam overflow, wherein the first holding means further comprises:
a. an inlet passage, wherein the inlet passage is adjacent to and in communication with a second open end of the first hose barb junction;
b. a float valve;
c. a gasket between the second open end of the hose barb junction and the inlet passage of the first holding means, wherein the gasket is adjacent to and in communication with both the second open end of the first hose barb junction and the inlet passage of the first holding means;
d. a fourth pin clamp member, wherein the fourth pin clamp member holds the inlet passage of the first holding means to the second open end of the first hose barb junction;
e. a first outlet passage;
f. a pressure relief valve;
g. a gasket between the pressure relief valve and the first outlet passage of the first holding means, wherein the gasket is adjacent to and in communication with both the pressure relief valve and the first outlet passage of the first holding means;
h. a fifth pin clamp member, wherein the fifth pin clamp member holds the pressure relief valve to the first outlet passage of the first holding means;
i. a second outlet passage;
j. a first micron filter inside the first holding means wherein the first micron filter is adjacent to and in communication with the second outlet passage of the first holding means;
e) a shut off valve, wherein the shut off valve further comprises;
a. a first open end inlet passage
b. a second open end outlet passage
c. a first gasket between the first open end inlet passage of the shut off valve and the second outlet passage of the first holding means;
d. a sixth pin clamp member, wherein the sixth pin clamp member holds the first holding means to the first open inlet passage of the shut off valve;
e. a second gasket between the second open end outlet passage and the first open end of the second holding means;
f. a seventh pin clamp member, wherein the seventh pin clamp member holds the second open end outlet passage of the shutoff valve to the inlet passage of the second holding means;
f) a second holding means, wherein the second holding means further comprises:
a. an inlet passage of the second holding means, wherein the inlet passage of the second holding means is adjacent to and in communication with the second open end outlet passage of the shut off valve;
b. a gasket between the inlet passage of the second holding means and the second open end outlet passage of the shut off valve, wherein the gasket is adjacent to and in communication with both the outlet passage of the first holding means and the second open end outlet passage of the shut off valve;
g) a second hose barb junction which further comprises:
a. an inlet passage;
b. an outlet passage;
c. a first open end;
d. a second open end;
e. a hose barb connection;
f. a second micron filter wherein the second micron filter is adjacent to and in communication with the first open end of the second hose barb junction and the outlet of the second holding means;
g. a gasket between the first open end of the second hose barb junction and the first outlet passage of the second holding means wherein the gasket is adjacent to and in communication with both the first open end of the second hose barb junction and the outlet passage of the second holding means;
h. an eighth pin clamp member that holds the first open end of the second hose barb junction to the outlet of the second holding means;
h) a cover for the second hose member further comprising:
a. a first open end;
b. a second open end;
c. a gasket between the first open end of the cover for the second hose member and the second open end of the second hose barb junction wherein the gasket is adjacent to and in communication with both the first open end of the cover for the second hose member and the second open end of the second hose barb junction;
d. a ninth pin clamp member that holds the first open end of the cover for the second hose member to the second open end of the second hose barb junction;
i) a second hose member that connects to the hose barb connection on the second hose barb junction and to a dispensing faucet.

2.-33. (canceled)

34. A modular liquid infusing, flavoring and dispensing device comprising:
a first hose member with first open end and second open end wherein the first open end is configured for fluid communication with a liquid source;
first holding means having a first inlet, first outlet and second outlet, wherein the second open end of the first hose member is in fluid communication with the first holding means;
a shut off valve in fluid communication with the second outlet of the first holding means;
second holding means having a second inlet and third outlet, where the second inlet is in fluid communication with the shut off valve and the second holding means is adapted to hold a flavoring substance;
a dispensing faucet; and
a second hose member having first and second open ends, wherein the first open end is in fluid communication with the third outlet of the second holding means, and the second open end is in fluid communication with the dispensing faucet.

35. The device of claim 34 further comprising a pressure relief valve in fluid communication with the first outlet of the first holding means.

36. The device of claim 34, wherein the second holding means contains a flavoring substance and further comprises a first mesh filter located between the shut off valve and second inlet of the second holding means

37. The device of claim 36, wherein the first mesh filter screen has a convex shape and protrudes into the second holding means.

38. The device of claim 34, wherein the second holding means is reversibly connected and secured with tri-clamp fittings.

39. The device of claim 34, further comprising a second mesh filter located at third outlet of the second holding means.

40. The device of claim 39 wherein the second mesh filter has a mesh size between 10 and 120 mesh.

41. The device of claim 34, wherein the first hose member has an interior diameter between 0.125″ and 1″ and wherein the second hose member has an interior diameter between 0.065″ and 0.5″.

42. The device of claim 41 wherein the combination of interior diameter and length of the second hose member collectively adds between 1 and 50 PSIG of flow resistance.

43. The device of claim 34, wherein the first hose member is connected to the first holding means through a hose barb adapter feature and the second hose member is connected to the third outlet of the second holding means through a hose barb adapter feature.

44. The device of claim 34, further comprising a pipe tower member and pipe neck member, wherein the pipe tower and pipe neck are connected to each other and the first hose member extends through the pipe tower member and pipe neck member.

45. The device of claim 34, wherein the second holding means is cylindrically shaped with an interior diameter between 2″ and 4″ and has a capacity between 40 and 80 fluid ounces.

46. The device of claim 34, further comprising a tapped source of a liquid that is in fluid communication with the first hose member, first holding means, second holding means, second hose member and a dispensing member, wherein the second holding means is pressurized to between 1 and 50 psi (gauge units) when in fluid communication with the tapped liquid source and the shut off valve is open and the pressure relief valve is closed.

47. A process of infusing and flavoring a beverage which comprises:
providing a liquid from a tapped source in fluid communication with the first hose member of the device of claim 34;
providing a flavor enhancing material in the second holding means;
contacting the liquid with the flavor enhancing material for a period of time sufficient to allow flavoring of the liquid;
dispensing the flavored liquid in to a drinking container in a manner such that the flavor enhancing material does not flow into the drinking container while also controlling the rate at which the flavored liquid is dispensed to reduce trauma to and foaming of the dispensed flavored liquid.

48. The process of claim 47 wherein the pressure in the second holding means is between 1 and 50 psi (gauge units) when the device is in fluid communication with the tapped liquid source, the shut off valve is open, and the pressure relief valve is closed.

49. The process of claim 47 wherein the device includes a pressure relief valve that is operatively associated with the dispensing of the flavoured beverage such that the relief valve opens to fill the second holding means with additional liquid.

50. The process of claim 47, which further comprises cooling the second holding means to cool the liquid therein to provide the flavoured beverage with minimal foaming and at an optimal drinking temperature to enhance drinking of the flavoured beverage.

51. The process of claim 47 wherein the liquid is beer and the flavouring material is fruit, vanilla beans, cinnamon sticks, malted barley or other beer hops, ice cream, spices, coffee beans, chocolate or other candy, chips, donuts or other baked cake products, bacon, ginger root, or combinations thereof.

52. The process of claim 47 wherein the second holding means is bounded on either end with a releasable clamp associate with the valves to allow simple replacement, refilling, or cleaning of the second holding means without disconnecting remaining components of the device from the tapped source.

53. The process of claim 47 wherein the liquid is infused with the flavouring material at a pressure of from about 1 to about 50 pounds per square inch, and the flavoured liquid is dispensed at a pressure of from about 1 to about 5 pounds per square inch, with the pressure of liquid flowing through the device controlled by varying the internal diameter and length of the first and second hose members.
